(19) United States
(12) Patent Application Publication
(10) Pub. No.: US 2009/0279409 A1
(43) Pub. Date: Nov. 12, 2009

(54) OPTIMAL DETECTION OF TWODOS SIGNALS

(75) Inventors: Alexander Marc Van Der Lee, Eindhoven (NL); Coen Theodorus Hubertus Fran Liedenbaum, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,624

(22) PCT Filed: Nov. 25, 2005
(86) PCT No.: PCT/IB2005/053909

§ 371 Date: Jun. 1, 2007

(30) Foreign Application Priority Data
Dec. 6, 2004 (EP) 04106314.0

(51) Int. Cl. G11B 7/135

(52) U.S. Cl. 369/112.23; G9B/7.112

(57) ABSTRACT

A method and a device for simultaneously reading information from a plurality of data tracks (14) of an optical disc (22) by means of a detector illuminating said plurality of data tracks with laser spots (25), wherein light reflected from the laser spots is collected by means of a servo lens (29), further providing the detector with a plurality of detector elements (28a, 28b, 28c, 31a, 42a, 28bc, 28cc, 32a, 32b, 42ac, 51a, 52a, 52b) spaced apart from each other, arranging each detector element to detect (read) light reflected from a data track allotted to each element, arranging at most two detector elements (28bc, 28cc, 32a, 32b, 42ac, 52a, 52b) to be segmented detectors for providing both a power signal for the allotted track and an output signal for focus error control in a servo system guiding said detector along said tracks, reading only the power signal for each track by means of second detector elements (28a, 28b, 28c, 31a, 42a, 51a) and arranging each one of said second detector elements to be of substantially smaller area than the area of one of said first detector elements.

The present invention refers to optical drives for reading or writing data from/to optical discs. Particularly, the invention has as an object to optimise the detectors used for read-out of information stored as pits in tracks of optical discs. An object of the invention is to make high frequency and low noise detection of the read-out possible.

Digital information is read from an optical disc or written on an optical disc along a track on the optical disc by use of an optical drive. A focus actuator in the optical drive is used to focus a laser beam to a spot onto the optical disc. The laser beam is focused by means of an object lens, which focuses the laser beam to a spot onto a data storing layer of the disc. As an example, a focusing actuator coil drives the object lens so that the object lens is focusing a focal point of the laser beam to form said spot on the data storing layer of the disc. A second coil, a tracking actuator coil, drives a tracking object lens, so that the spot is traced along the track of the disc.

In an optical drive a servo system is used to focus the focal point of the laser beam onto the data storing layer of the disc. A control loop for controlling said servo system is called the focus control loop. To guarantee a proper optical drive performance the focus control loop must be closed. An error signal for controlling the guidance of the laser beam in the servo system can be obtained from light reflected back from the data storing layer to a detector on a sledge carrying a light source for the laser beam. To capture focus the actuator is moved towards the disc. During the movement towards the disc, a reflected signal, called central aperture (CA) is monitored. If the signal exceeds a certain threshold level the actuator is close to the focussing point and a focus error signal is then monitored and controlled by the servo to preserve the laser beam focused.

In conventional optical storage devices the data is transferred to pits, which are arranged in a linear fashion (although curved in tracks, circular or in a spiral) on the optical disc. Information stored as data is read-out by means of a single spot from the track of pits. A two-dimensional (2D) encoded disc is different. The data is on a 2D encoded disc arranged in a two dimensional pattern of pits, wherein the data is read-out by means of multiple spots at the same time.

In a single track read-out system the detector is designed to read the arrangements of pits along the track and to convert the reading to an information carrying HF signal. At the same time, the detector is further designed as, for example, a quadrant or a split detector for generating an error signal to be used for tracking by the servo system.

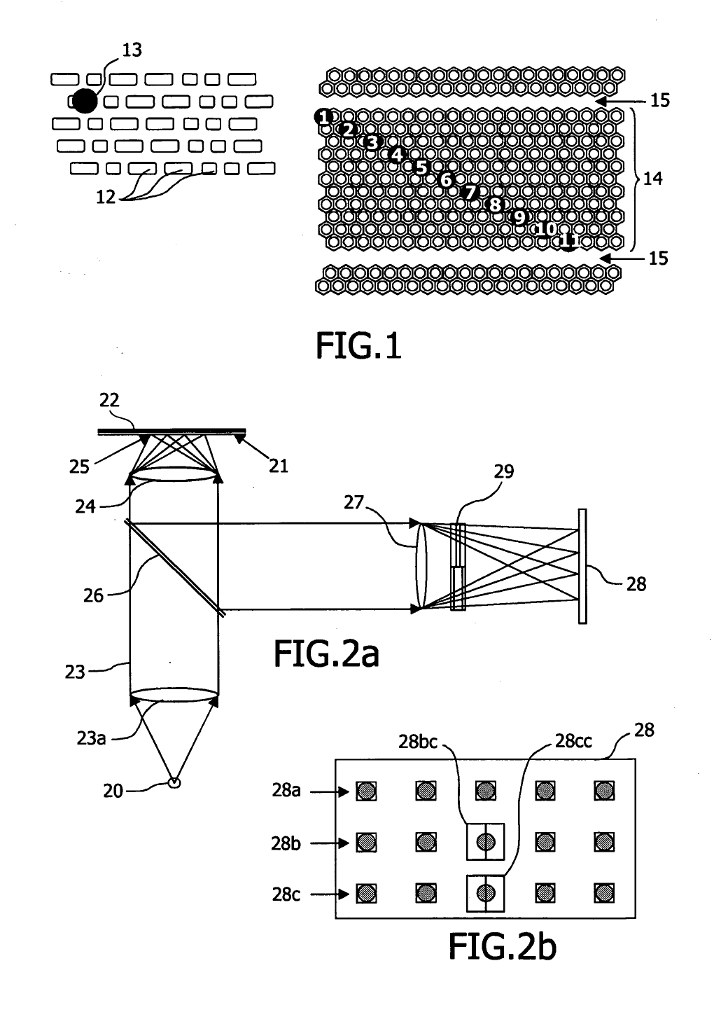

The difference between one-track read-out and read-out of data from the 2D-optical storage (abbreviated to TwoDOS from 2 Dimension Optical Storage) is illustrated in FIG. 1. The left part of FIG. 1 depicts five rows of pits 12 that form the separate tracks of an optical disc. A single laser spot 13 is guided to follow only one track to read out the data stored in the track. The right part of FIG. 1 illustrates the data layout on a 2D encoded disc (TwoDOS). In the 2D layout the data of the optical disc is contained in a broad meta-track 14, which consists of several rows of pits. As shown, in the example according to the figure, the meta-track contains 11 separate rows of data carrying pits. Each one of these separate rows of data pits is read out by a laser spot corresponding to a specific one of the separate rows of pits. This is indicated by means of the spots numbered from 1 up to 11 in the figure. These 11 spots are shown in the figure, for the sake of clarity, to be arranged in a line inclined in relation to the meta-track direction. However, the spots can be arranged in any other configuration to read the data. As an example, the spots 1-11 can be arranged in a line in which each spot is centered on a corresponding row of pits. The broad meta-track is enclosed by guard bands 15. Said guard bands are rows of empty space bordering the meta-track and with no data content.

US 2003/0206503 A1 discloses a multi-element detector for the use of reading multiple tracks of optical discs having different formats. The multi-element of said detector comprises detector elements, each of which detects light reflected from a corresponding track of an optical disc. It is shown in the disclosure that the multi-element detector includes a central detector element and a number of side detector elements. Each of the side detector elements has an elongated shape and is of a larger area than the central element.

Small detectors have a low capacitance, which makes detection of high frequency and low noise detection possible. Thus, it is a drawback to the read-out of data from an optical disc by use of a multi-element detector according to the disclosure of the prior art device as said detector elements will have comparatively high capacitances.

One object of the invention is to present a device and a method, which provides a multi-element detector having small detector elements and thus low capacitances enabling the use of said multi-element detector for high frequency and low noise detection of TwoDOS optical discs.

According to one aspect of the invention there is disclosed a device as specified in the independent device claim.

According to a further aspect of the present invention there is disclosed a method as specified in the independent method claim.

The detector needs to be able to generate a number N of CA signals (Centre Aperture signals), wherein N is the number of read-out laser beam spots. This is achieved by means of detector elements detecting the total power of light reflected back to the detector element from a spot. One or two of these detector elements must contain a quadrant or a split detector in order to generate the focus error signal.

The spots are normally arranged in a row, so the detector elements are also in a row. Of course other configurations like squares or a circle-like distribution of detector elements, are possible

Conventionally relative large (large refers to light detection area) detector elements are used because of alignment tolerances. This is especially valid for, for example, a quadcel detector element constituting a detector element having segmented detector elements delivering an error signal to the focus error control system, wherein the position of the centre of a spot is measured in relation to the position of the different detector segments. Such large detectors always suffer from a high parasitic capacitance, which leads to a lower bandwidth in the data reading signal and more electronic noise. For detection of the CA signals it is advantageous to have small detector elements. It is only useful to detect the CA signal from an allotted spot, when said spot is actually correctly focused on the disc, whereby said spot is as small as possible. This means that it is not necessary to use large area detector elements for those detector elements, whose only purpose is to detect the CA signals from the allotted spot. This fact is used according to the invention, wherein the detector elements are made as small as possible in relation to their respective task.

It is hence advantageous, according to an aspect of the present invention, to provide a photo detector of multi-element type, wherein small elements for the CA signals are combined with large detector element(s) used for servo control purposes.

These and other aspects of the invention will be apparent from and elucidated with reference to the embodiment(s) described hereinafter.

Application of the present invention is especially useful in all kind of devices where there is a need for high data rates as in PC data drives or archiving functionality.

FIG. 1 schematically shows the difference between one-track read-out and read-out of data from 2D-optical storage of information on an optical disc according to prior art.

FIGS. 2a and 2b schematically shows a first embodiment of the invention, wherein detector elements are arranged in three rows and with elements for each track of a multiple track storage of an optical disc. The laser bean arrangement is shown in FIG. 2a and the detector layout in FIG. 2b.

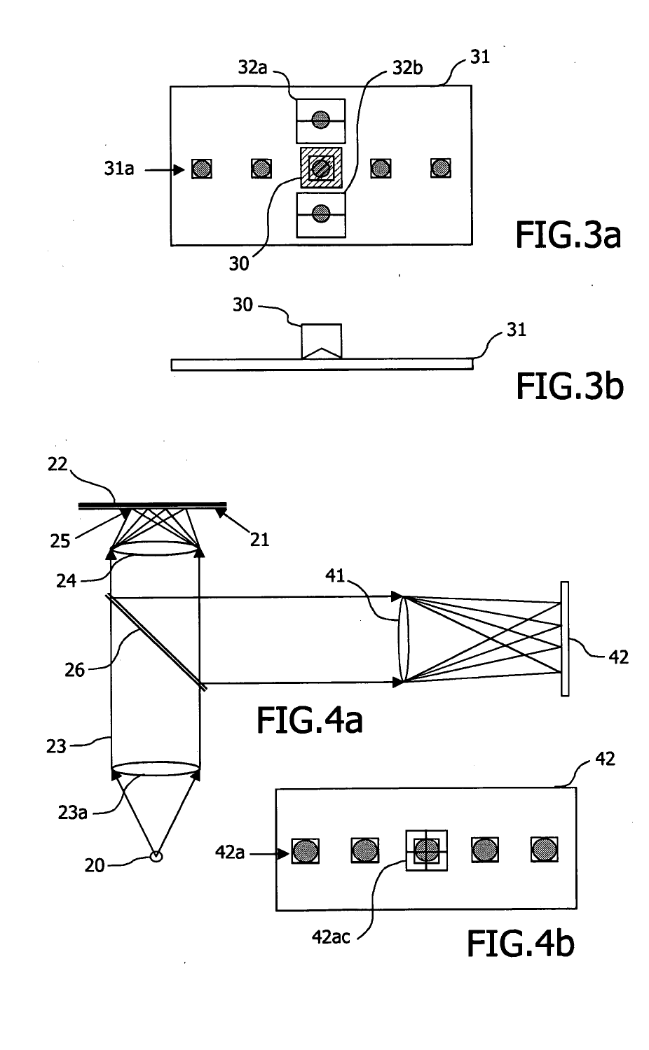

FIGS. 3a and 3b shows a second embodiment with one row of power reading detector elements and with two detector elements for reading an error signal used in the track guidance servo control loop and wherein FIG. 3b is a front view of the detector as seen in the detector plane.

FIGS. 4a and 4b shows a third embodiment of the invention with a detector element layout for an astigmatic focusing having one row of detector elements only and wherein FIG. 4b is the detector layout as seen from above.

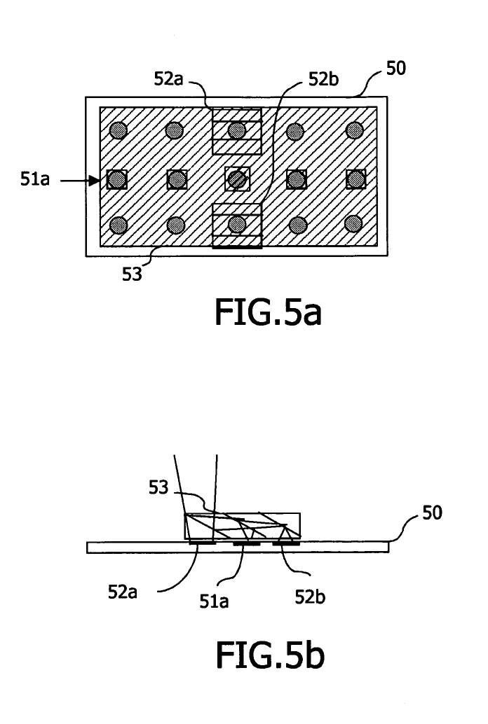

FIGS. 5a and 5b shows a fourth embodiment with a detector layout for an astigmatic focusing having three rows of power reading detector elements, wherein FIG. 5b is a cross section of the detector layout as seen in the detector plane in the direction illustrated by arrow 51a.

A number of embodiments for performing the method according to the invention will be described in the following supported by the enclosed drawings.

In FIG. 2a there is depicted, very schematically, an example of a Foucault arrangement of a first embodiment of the invention. Multiple light spots are projected to a data layer 21 arranged at the surface of an optical disc 22. The multiple light spots can be generated in various ways, either from multiple lasers or from a single laser in combination with a grating or holographic element. In the FIG. 2a a laser is chosen as a light source 20 and split by a grating (not shown) into multiple light sources. Light from these multiple light sources are then concentrated to parallel laser beams 23 in a first lens 23a before arriving at the objective lens 24, which projects the light beams as multiple spots 25 at the data layer 21. The separation of the spots in the data layer plane is of the order of magnitude 2,8 lambda/NA_obj, wherein NA_obj is the NA of the objective lens 24 and lambda the wavelength. In this embodiment Foucault edge detection is applied. To determine the optimal focus position the beam is split into two parts, an upper half and a lower half. By monitoring the centre of mass of the two separate spots the position of focus can be determined. Typical values for Blu ray Disc are NA_obj=0.85, lambda=405 nm. The number of spots 25 in the example is limited to five for the sake of simplicity, but can easily be extended to a number N of spots.

Light reflected back from the laser spots 25 from the data layer 21 is directed to a detection branch of the detector by means of a semitransparent mirror 26 in an angle to one side or a PBS in combination with a quarter wave plate. The servo lens has as a purpose to focus the light reflected from the respective spot to detector elements 28a, 28b, 28c of a detector 28. Each detector element is aimed to receive light reflected from an allotted spot.

According to the embodiment the detector has a layout as shown in FIG. 2b. It is thus disclosed a layout of a multi-element detector 28 having 3 rows of detector elements 28a, 28b, 28c. The detector elements 28a, 28b, 28c of each row are for the sake of clarity indicated by means of arrows, named 28a, 28b and 28c pointing at the detector elements represented by squares. The servo lens 27 provides a first spectrum of each spot on the detector 28. Light incident from each spot 25 is further diffracted weakly by means of a split grating 29 into a second and a third spectrum. The first spectrum is used for CA detection on detector elements 28a, the second spectrum provided by one part of grating 29 is projected at detector elements 28b, and the third spectrum provided by another part of grating 29 is projected at detector elements 28c. Detector elements 28b and detector elements 28c are used for Foucault edge detection, as is known in prior art. As is described and shown in FIG. 2b also the second spectrum and the third spectrum are incident on CA detector elements, four of them indicated by arrows 28b and 28c. Another option is of course to omit CA detectors 28b and 28c.

In the embodiments as disclosed in the drawings the detector elements are represented by squares, while light spots are represented as circles.

In the detector layout the first spectrum is arranged to be focused on a first row of detector elements 28a. This first row of detector elements 28a is in this embodiment composed by small area detector elements as the purpose is to measure the total power of the light reflected back from the specific spot (the CA signal). Most of the power of the light reflected from the respective spot is concentrated in a circular area with a diameter lambda/NA. By this, a central aperture (CA) detector element 28a does not need to be greater than 1,22 lambda/NA and still allow an alignment tolerance of positioning the beam on the detector to be large enough (note that the NA mentioned here is the NA of the servo lens 27).

A second row of detector elements 28b is arranged on the detector 28 to receive light from the second spectrum of the light reflected back from the spots 25. A third row of detector elements 28c is also arranged on the detector 28 to receive light from the third spectrum of the light reflected back from the spots 25. For convenience only 5 detector elements per row is illustrated, but the number of elements can in correspondence to the layout be extended to any proper number of detector elements per row. According to this embodiment only the two centre detector elements 28bc and 28cc of the two rows of detector elements 28b and 28c arranged in the detector 28 need to be larger then the CA measuring detector elements 28a, 28b, 28c as they are segmented detector elements measuring an error signal for the focusing of the laser beam 23.

According to a second embodiment, disclosed in FIG. 3a and FIG. 3b, Foucault technique is used. The overall device arrangement is the same as in the previous disclosed embodiment as shown in FIG. 2a. The detector arrangement and the focusing of the spots on the detector is, however, somewhat different. The split grating 29 is not used in this embodiment. An optical member 30 is instead integrated on a photo detector 31. Said optical member 30 splits the spectrum of the centre light spot in an upper half (first spectrum part) and a lower half (second spectrum part). In this embodiment a first spectrum only provided by the servo lens 27 is used, whereby there is arranged only one row of detector elements 31a for the CA detection of the first spectrum of light from the respective spot. There is thus provided five CA detector elements in the row of detector elements 31a. The optical member 30 can be accomplished by means of a micro prism arranged right above the image of the centre spot of the row of images of spots incident on detector 31 on the row of detector elements 31a for generating reflected images of said centre spot. As an alternative, said reflected images of the centre spot may instead be provided by means of a micro prism.

In FIG. 3a it is illustrated servo detectors 32a and 32b, arranged orthogonally to the row 31a of CA detector elements, one on each side of the centre CA detector element. These servo detectors 32a and 32b are provided with segmented detector elements to measure an error signal for focus control of the laser beam 23. The amount of light that scatters towards the focus servo detectors 32a and 32b can be controlled, e.g. by use of refractive index contrast of the materials in the case wherein a micro prism is utilized.

According to yet another, a third, embodiment, astigmatic focussing of the laser beam 23 on the track of the optical disc is used. This is shown in FIGS. 4a and 4b. The overall arrangement of accomplishing the laser spots 25 on the plurality of tracks 14 on the optical disc 22 is the same as in the previously disclosed embodiments, but for the servo lens 27, the grating 29 and the detector. The servo lens is according to this embodiment an astigmatic servo lens 41 (substituting both the servo lens 27 and the grating 29 of the previous embodiments) and the detector 42 has in this example a layout according to FIG. 4b.

Also, in this third embodiment of FIG. 4a and 4b the spots are not split by a grating but the astigmatism of the spots gives the focus information. The CA measuring detector elements 42a are also in this case arranged in a row. In this case the images of the spots will be larger in focus due to the astigmatic aberration introduced by the astigmatic servo lens 41. Hence all the CA detection elements 42a in the row will be somewhat larger than the corresponding detection elements of the previously described embodiments. In this case it is further possible to split up a standard quad cell in an inner HF detector and outer quadcell detector elements that captures the focusing information. In this embodiment it is possible to use only one centre detector element 42ac for both detecting the CA signal of the centre spot and generating the error signal for the servo system.

In FIG. 5a there is a further configuration for spot size detection exemplified as a fourth embodiment. This is depicted for a detector 50 having a layout, which shows that also for spot size detection the detectors can be divided in detector elements 51a that measure the total spot CA signal and larger segmented detector elements 52a, 52b for the focus error signal. On top of the detector 50 a segmented glass plate 53 is arranged that separates light incident from one spot into three spots. Hence each spot will be projected as three separated spots as indicated in FIG. 5a, while CA detector elements are arranged only in a centre row 51a. A cross section through the segmented detector elements 52a and 52b and the glass plate as seen in the plane of the detector 50 in the direction as indicated by arrow 51a is illustrated in FIG. 5b. The overall arrangement of the detector is otherwise the same as in the second embodiment of the invention as discussed above. The splitting of the focus detection detectors is now in three parts, which is caused by the glass plate 53. The beam path of the light incident on detector 50 is depicted in FIG. 5b.

Further, in FIGS. 2b, 3a, 4b and 5a only five detector elements are depicted along the row of CA detector elements 28a, 31a, 42a and 51a respectively, but the number of elements can easily be extended.

The method and device according to the invention can be applied in all optical recording devices, but it is especially useful for data drives as the data rates are the highest for this application due to speed race.

Although the present invention has been described in connection with specific embodiments, it is not intended to be limited to the specific form set forth herein. Rather, the scope of the present invention is limited only by the accompanying claims. In the claims the terms comprising and including do not exclude the presence of other elements or steps. Furthermore, although individually listed a plurality of means, elements or method steps may be implemented by e.g. a single unit or processor. Additionally, although individual features may be included in different claims, these may possibly be advantageously combined and the inclusion in different claims does not imply that a combination of features are not feasible and/or advantageous. In addition, singular references do not exclude a plurality. Thus references to “a”, “an”, “firs”, “second” etc. do not preclude a plurality. Reference signs in the claims are provided merely as clarifying examples and shall not be construed as limiting the scope of the claims in any way.

1. A multi-element detector for use in simultaneously reading a plurality of data tracks (14) from an optical disc (22), comprising:
a servo lens (27, 41) for collecting light reflected from laser spots (25) illuminating said plurality of data tracks (14) arranged on the optical disc (22),
characterized in that the multi-element detector has:
first detector elements (28bc, 28cc, 32a, 32b, 42ac, 52a, 52b) being segmented detectors providing both a power signal for light reflected from a laser spot (25) of an allotted track and an output signal for focus error control in a servo system guiding said detector along said tracks (14),
second detector elements (28a, 28b, 28c, 31a, 42a, 51a) reading only the power signal for each track, wherein the area of one of said second detector elements is substantially smaller than the area of one of said first detector elements.

2. The multi-element detector according to claim 1, comprising at most two first detector elements.

3. The multi-element detector according to claim 1 further comprising a spot light splitting member (29, 30, 53) for splitting light reflected from at least one spot into a number of spectra of said spot,

4. The multi-element detector according to claim 3, wherein said second detector elements (28b, 28c, 31a, 42a, 51a) has a light detecting area less than (2 lambda/NA)² and preferably less than (1,25 lambda/NA)².

5. The multi-element detector according to claim 1, wherein said second detector elements (28a, 28b, 28c, 31a, 42a, 51a) are arranged in rows.

6. The multi-element detector according to claim 5, wherein the first detector elements (28bc, 28cc, 32a, 32b, 42ac, 52a, 52b) are divided in quadrants or constitute split detectors.

7. The multi-element detector according to claim 3, wherein said spot light splitting member is a grating (29) for providing a second and a third spectrum of each spot and wherein said second detector elements (28a) read the power signals of at least a first spectrum of each spot.

8. The multi-element detector according to claim 7, wherein a first of the at most two first detector elements (28bc, 28cc,) reads a second spectrum of one of the spots.

9. The multi-element detector according to claim 8, wherein a second of the at most two first detector elements (28bc, 28cc) reads a third spectrum of one of the spots.

10. The multi-element detector according to claim 3, wherein said spot light splitting member is an optical member (30, 53) arranged on the detector (31) for reflecting light incident on the detector (31, 50) from one of the spots (25) illuminating the tracks (14) of the optical disc (22) for establishing a second and a third spectrum of the light from said one spot.

11. The multi-element detector according to claim 10, wherein said second detector elements (31a, 51a) read the power signals of a first spectrum only of each spot.

12. The multi-element detector according to claim 11, wherein said first detector elements (32a, 32b, 52a, 52b) read the second and the third spectrum of one spot only.

13. The multi-element detector according to claim 1, wherein said servo lens is an astigmatic servo lens (41).

14. The multi-element detector according to claim 13, wherein said second detector elements (42a) read the power signals of a first spectrum only of each spot.

15. The multi-element detector according to claim 13, wherein a first detector element (42ac) reads the first spectrum of only one spot.

16. A method for simultaneously reading information from a plurality of data tracks of an optical disc (22) by means of a multi-element detector, comprising the steps of:
illuminating said plurality of data tracks (14) with laser spots (25),
collecting light reflected from said laser spots (25) by means of a servo lens (27, 41),
providing said detector (28, 31, 42, 50) with a plurality of detector elements (28a, 28b, 28c, 31a, 42a, 51a, 28bc, 28cc, 32a, 32b, 42ac, 52a, 52b) spaced apart from each other,
arranging each detector element (28a, 28b, 28c, 31a, 42a, 51a, 28bc, 28cc, 32a, 32b, 42ac, 52a, 52b) to detect light reflected from a data track allotted to each detector element,
arranging first detector elements (28bc, 28cc, 32a, 32b, 42ac, 52a, 52b) to be segmented detectors for providing both a power signal for the allotted track and an output signal for focus error control in a servo system guiding said multi-element detector along said tracks (14),
reading only the power signal for each track by means of second detector elements (28a, 28b, 28c, 31a, 42a, 51a) and
arranging said second detector elements (28a, 28b, 28c, 31a, 42a, 51a) to be of substantially smaller area than the area of said first detector elements (28bc, 28cc, 32a, 32b, 42ac, 52a, 52b).

17. The method according to claim 16, wherein the step of arranging first detector elements arranges at most two detector elements.

18. The method according to claim 16, further comprising the step of:
splitting said collected light of at least one spot by means of a light splitting member (29, 30, 53) into a number of spectra.

19. The method according to claim 18, further comprising the step of:
splitting light reflected from all of the spots (25) into a first second and a third spectrum by means of a grating (29) or
splitting light reflected from one spot only into a first, a second and a third spectrum by means of an optical member (30), such as a micro prism, a split grating or by means of a segmented glass plate (53).
